(19) United States
(12) Patent Application Publication
(10) Pub. No.: US 2018/0338214 A1
(43) Pub. Date: Nov. 22, 2018

(54) Personal Speaker System

(71) Applicant: Raytheon BBN Technologies, Corp., Cambridge, MA (US)

(72) Inventors: Zachary Eric Leuschner, Annapolis, MD (US); John-Francis Mergen, Baltimore, MD (US)

(73) Assignee: Raytheon BBN Technologies, Corp.

(21) Appl. No.: 15/599,307

(22) Filed: May 18, 2017

(51) Int. Cl. H04S 7/00; H04R 3/12; H04R 5/02; H04R 1/02; H04R 5/04

(52) U.S. Cl. CPC H04S 7/303; H04R 3/12; H04R 2420/07; H04R 1/025; H04R 5/04; H04R 5/02

(57) ABSTRACT

Personal audio speaker system technology is disclosed. A personal audio speaker system can include a support structure, and a plurality of speakers supported by the support structure. The plurality of speakers can receive adjusted audio signals based on the distance between each of the plurality of speakers and the target location such that sound waves produced from the plurality of speakers superpose in constructive interference at the target location.

### BACKGROUND

Video chatting technologies, such as FaceTime® and Skype™, are at the fingertips of millions of smartphone users. These applications bring people together in a convenient forum, but may also inadvertently bring others into the conversation as these applications offer little in the way of privacy, particularly when used on mobile devices and in locations with no expectation of privacy. Moreover, without headphones, these conversations can be overheard by others, which can be a nuisance.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein;

FIG. 1 is an illustration of a mobile electronic device in accordance with an example of the present disclosure relative to a user.

FIG. 2 is a front view of the mobile electronic device of FIG. 1.

FIG. 3 is a schematic representation of the mobile electronic device of FIG. 1 showing operational systems.

FIG. 4 is an illustration of a personal audio speaker system in accordance with an example of the present disclosure.

FIG. 5 is a schematic representation of the personal audio speaker system of FIG. 4 showing operational systems.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

An initial overview of the inventive concepts is provided below and then specific examples are described in further detail later. This initial summary is intended to aid readers in understanding the examples more quickly, but is not intended to identify key features or essential features of the examples, nor is it intended to limit the scope of the claimed subject matter.

Although headphones can enable users to effectively hear and communicate with one another while video chatting, using headphones can be difficult or inconvenient for some users, particularly those with hearing aids or other hearing constraints. Without the use of headphones, people in the surrounding area can hear the video chat conversation. Some users who are hearing impaired may elevate the volume in an attempt to hear and may not be able to hear clearly even at elevated volumes, which can create an even bigger nuisance for other people in the vicinity. Thus, many users of video chat applications can benefit from technology that enables them to hear clearly at a suitable volume without disturbing other people and without relying on headphones.

Accordingly, a personal audio speaker system is disclosed that can maximize the received audio volume for the recipient user while minimizing the impact on people in the surrounding area. The personal audio speaker system can include a support structure, and a plurality of speakers supported by the support structure. The plurality of speakers can receive adjusted audio signals based on the distance between each of the plurality of speakers and the target location, such that sound waves produced from the plurality of speakers superpose in constructive interference at the target location.

In one aspect, a mobile electronic device can include a support structure, and a plurality of speakers supported by the support structure. The mobile electronic device can also include a distance measuring system to determine a distance between each of the plurality of speakers and a target location about a user. In addition, the mobile electronic device can include a processor that receives an input audio signal and generates adjusted audio signals for the plurality of speakers based on the distance between each of the plurality of speakers and the target location, such that sound waves produced from the plurality of speakers superpose in constructive interference at the target location.

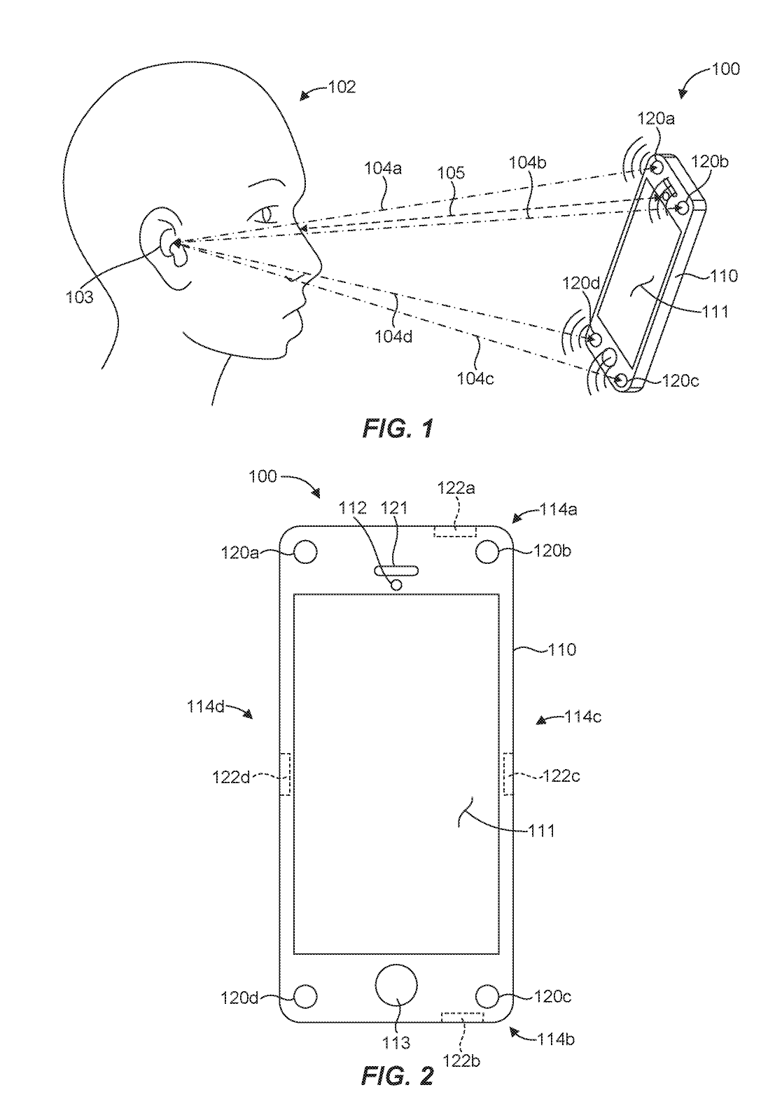

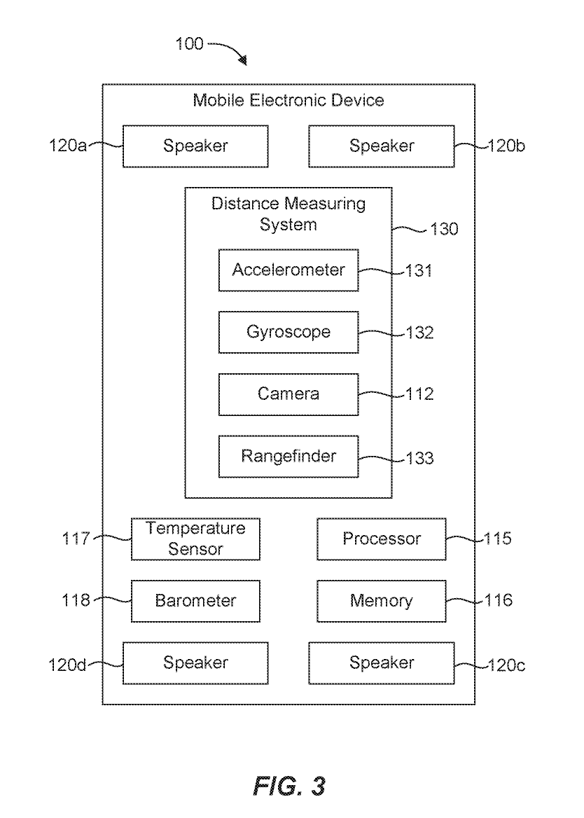

One example of a mobile electronic device 100 is illustrated in FIGS. 1-3. The mobile electronic device 100 is shown relative to a user 102 in FIG. 1, isolated for clarity in FIG. 2, and schematically representing operational systems in FIG. 3. The mobile electronic device 100 can comprise any suitable type of mobile electronic device, such as a smart phone, a tablet, a wearable device, a laptop computer, etc. The mobile electronic device 100 can have a support structure 110, which can include any external support structure (e.g., a typical housing, casing, or shell) and/or any internal support structure (e.g., a motherboard) of a smart phone, tablet, etc. The mobile electronic device 100 can include a screen or display 111 (e.g., a touch screen) typical of mobile devices supported by the support structure 110 and configured to be oriented toward the user 102 during use. The mobile electronic device 100 can also include a camera 112 or other suitable optical sensor typical of mobile devices (e.g., operable in the visible and/or non-visible light spectrum). One or more buttons 113 or other user interface features typical of mobile devices can also be included to facilitate use and operation of the mobile electronic device 100 by the user 102.

The mobile electronic device 100 can also include multiple speakers 120a-d supported by the support structure 110. The speakers 120a-d can be any suitable type of electroacoustic transducer. The speakers 120a-d can be in any suitable location about the mobile electronic device 100. For example, as shown in the figures, the speakers 120a-d can be located on a screen side of the mobile electronic device 100 and positioned proximate corners on the screen side face of the device (e.g., surrounding the screen 111). In this case, the speakers 120a-b are located proximate a top end 114a of the mobile electronic device 100, and the speakers 120c-d are located proximate the bottom end 114b of the mobile electronic device 100. Although in the illustrated embodiment the speakers 120a-d face the same direction (i.e., away from the screen side of the mobile electronic device 100), it should be recognized that speakers of the mobile electronic device 100 utilized in accordance with the present disclosure can face or be directed in any suitable direction. In addition, it should be recognized that the mobile electronic device 100 can include any suitable number of speakers utilized in accordance with the present disclosure. In some embodiments, the mobile electronic device 100 can include the four speakers 120a-d shown in the illustrated example.

In addition, in some examples the mobile electronic device 100 may include a speaker 121 that is configured as an “earpiece” speaker for when the user 102 is using the mobile electronic device 100 as a phone with the speaker 121 positioned proximate the user's ear 103. Such an “earpiece” speaker 121 is typically located proximate the top end 114a of the mobile electronic device 100. As shown in FIG. 2, the mobile device 100 can optionally include one or more speakers 122a-d located on top 114a, bottom 114b, and/or lateral sides 114c-d of the device. The speakers 122a-d can face or be oriented to direct sound from the respective top 114a, bottom 114b, and/or lateral sides 114c-d the mobile electronic device 100. Any speaker of the mobile electronic device 100 can form part of a personal audio speaker system in accordance with the present disclosure.

As discussed in more detail below, various speakers of the mobile electronic device 100 can be utilized to produce sound waves that will arrive at a target location or zone about the user 102 (e.g., the user's ears 103) at the same time, such that the sound waves reinforce in constructive interference to increase sound pressure level (SPL) at the target location or zone. This can be accomplished by determining the distance between the various speakers of the mobile electronic device 100 and the user 102 and delaying the sound produced by the closer speakers relative to the farthest speaker(s) so that the sound from all the speakers arrives at the target location or zone at the same time.

Accordingly, as shown in FIG. 3, the mobile electronic device 100 can include a distance measuring system 130 to determine a distance 104a-d (FIG. 1) between each of the respective speakers 120a-d the user 102 (e.g., a target location or zone about the user 102, such as the user's ears 103). The distance measuring system 130 can comprise any suitable device or sensor that can be used to determine a distance 105 between a point or location on the mobile electronic device 100 and a target location or zone about the user 102 (e.g., the user's ears 103). For example, the distance measuring system 130 can include the camera 112, an accelerometer 131, a gyroscope 132, and/or a rangefinder 133 (e.g., an RF rangefinder, an ultrasonic rangefinder, a laser rangefinder, etc.). As is typical of many mobile electronic devices, the mobile electronic device 100 can include a processor 115 and one or more memory devices 116 including a data store to store data and instructions. In one aspect, the distance measuring system 130 can utilize the processor 115 and memory devices 116 to determine the distance 105 and/or the distances 104a-d between the respective speakers 120a-d and a target location or zone about the user 102.

Any suitable technique or process known in the art may be utilized to determine the distance 105 and/or the distances 104a-d between the respective speakers 120a-d and a target location or zone about the user 102. For example, the camera 112 can be used to determine the distance 105 between the camera 112 and the user 102 (e.g., the nearest part of the user's head, such as the user's face or a specific target location of the user's head, such as the user's ears 103) based on an image of the user's head using known techniques (e.g., autofocus techniques that compare contrast between pixels in multiple images, etc.). In one aspect, the camera 112 can be used to identify the user's ears 103 and determine a distance between the camera 112 and the user's ears 103. In some examples, the distance 105 can be determined using the optional rangefinder 133 (e.g., laser, radar (RF), sonar, lidar, and/or ultrasonic transmissions).

The orientation of the mobile electronic device 100 relative to the target location or zone about the user 102 can also be determined by any suitable technique or process known in the art. For example, the orientation of the mobile electronic device 100 relative to the target location or zone about the user 102 can be determined using known techniques (e.g., comparing facial distortion in images, determining the location of the user's face in the camera's field of view, etc.). Rangefinders also can include technology that can determine the relative angle or orientation of the rangefinder and the subject object. In some examples, multiple sensors (e.g., multiple cameras and/or rangefinders) can be used together (e.g., parallax effect for optical sensors) to determine the distance 105 and orientation between the mobile electronic device 100 and the user 102.

Because the various speakers of the mobile electronic device 100 (e.g., the speakers 120a-d) are at known positions relative to a given point on the device (e.g., the camera 112 and/or the rangefinder 133), once the position and orientation of the mobile electronic device 100 relative to the user 102 is known, the distances 104a-d between the respective speakers 120a-d and a target location or zone about the user 102 can be determined using geometry and trigonometry techniques. For example, the distances 104a-d of the speakers 120a-d can be determined by constructing triangles between the camera 112, the respective speakers 120a-d, and the target location about the user 102 using known distances and the angle of the mobile electronic device 100. In some embodiments, the accelerometer 131 and/or the gyroscope 132 can be used to determine the distances 104a-d of the speakers 120a-d relative to the user 102 (e.g., by contributing directional and/or rotational movement data to “track” the target location or zone about the user 102, determine the angle of the mobile electronic device 100, etc.).

With the distances 104a-d between the respective speakers 120a-d and a target location or zone about the user 102 determined, audio signals for the speakers 120a-d can be adjusted based on the distances 104a-d such that sound waves produced from the speakers 120a-d superpose in constructive interference at the target location creating a zone of constructive interference that effectively increases the sound pressure level (i.e., volume) at the user's head (e.g., ears 103). For example, the adjusted audio signals can be phase-shifted or delayed such that the sound waves produced by the speakers 120a-d, which may be at different distances 104a-d from the target location, are substantially in phase when the sound waves reach the target location or zone about the user 102. Adjusted audio signals or phase-shifting of the original input audio signal can be accomplished using an analog circuit and/or digital signal processing techniques. In one embodiment, the processor 115 can receive an input audio signal and generate adjusted audio signals for the speakers 120a-d that phase-shifts the original input signal based on the distances 104a-d between the speakers 120a-d and the target location.

In one aspect, a temperature sensor 117 (e.g., a thermocouple) can be included and configured to determine the ambient air temperature. This can be used to determine the speed of sound through the air, which can vary with temperature. The speed of sound through the air can be used to calculate the arrival time of the sound waves from the speakers 120a-d at the respective distances 104a-d from the target location about the user 102 when determining the delay or phase shift of the audio signals provided to the speakers 120a-d. In addition, a barometer 118 typical of many mobile electronic devices can be used to determine the speed of sound in the air.

The speaker at the greatest distance or farthest from the target location or zone about the user 102 can be referred to as a reference speaker because the audio signals for the closer speakers can be adjusted using the farthest speaker as a reference for calculating the delay or phase-shifts for the adjusted audio signals sent to the closer speakers. Thus, the original input audio signal can be sent to the reference speaker and the adjusted or phase-shifted audio signals can be sent to the closer speakers such that the sound waves produced by the speakers 120a-d arrive substantially in phase and superpose in constructive interference at the target location. Thus, the array of speakers 120a-d can produce sound waves according to calculated timing (e.g., each “closer” speaker receiving an individually specific phase-adjusted or delayed signal) that causes the sound waves from the speakers 120a-d to superpose in constructive interference at a target location or zone. Sound waves can therefore be transmitted in the direction of the user 102 (e.g., in the same direction from the speakers 120a-d) and reinforced in a zone around the target location (e.g., the user's optimal hearing point) to make the sounds louder for the user while minimally disturbing nearby or surrounding people. In other words, the audio signals provided to the speakers 120a-d can be configured to provide beamforming of the sound waves analogous to RF beamforming with antennas. Thus, the sound wave or acoustic “beam” generated by the speakers 120a-d can be directional to provide a zone of constructive interference about the user's head or ears 103 from sound waves emanating from the mobile electronic device 100. The direction of the acoustic beam from the mobile electronic device 100, and therefore to location of the zone of constructive interference, can be configured to track a desired target location (e.g., the user's ears 103) in real-time by dynamic phase variation of the adjusted audio signals. Thus, the mobile electronic device 100 can detect the current relative positions of the speakers 120a-d and the target location in real-time to dynamically adjust the delay or phase shift of the audio signals provided to the speakers 120a-d. Any suitable number of speakers can be utilized to deliver more sound pressure level to the user 102 without delivering more sound pressure level to nearby people around the user. Although any suitable number of speakers can be utilized, four speakers may be sufficient to provide acceptable sound isolation for the user 102.

Software to gather the relative distance data of the speakers 120a-d and the target location, and to generate the adjusted audio signals (i.e., to track the target location and direct the acoustic beam) can be integrated into the mobile electronic device 100 and/or provided in an application (i.e., an “app”) that runs on the mobile electronic device 100. When using the camera 112 to acquire distance data, the delay or phase shift adjustments can be recalculated as fast as the camera 112 can provide image data (e.g., camera framerate). The audio delay or phase shift adjustment calculation rate can be dynamically adjusted based on the degree of relative motion experienced. For example, rapidly changing relative positions between the mobile electronic device 100 and the target location can lead to high calculation rates of the delay or phase shift adjustment to effectively track and maintain sound wave constructive interference at the target location. On the other hand, a somewhat steady relative position between the mobile electronic device 100 and the target location can lead to low calculation rates of the delay or phase shift adjustment as there is little variation needed in the delay or phase shift to maintain sound wave constructive interference at the target location.

The mobile electronic device 100 disclosed herein can be used to provide an enhanced listening experience for any type of audio source material, such as voice or music, while minimizing disturbance to nearby people. For example, the mobile electronic device 100 can be used for a video chat by a person in a public place to provide adequate volume of the conversion for the user without disturbing people in the surrounding area. When the video chat begins, the user 102 can hold or position the mobile electronic device 100 at a suitable location for comfortable viewing of the screen 111 and for capturing a proper-sized image of the user's face for the other person to view. This is typically about half an arm's length to an arm's length from the user's face, although the location can vary from person to person. While the mobile electronic device 100 is being positioned, the mobile electronic device 100 can perform a live calibration to determine where the user's face is with respect to the mobile electronic device 100, in order to determine where the target audio focal point or location will be for the user, and relative distances between the target location and the speakers that may be utilized. When the calibration is complete, the mobile electronic device 100 can automatically generate sound waves that constructively interfere at the target location about the user's head as described above, and/or the user can have the option to choose this enhanced audio setting or a conventional audio setting.

During the video chat, the mobile electronic device 100 can receive audio and video information from the sender. The mobile electronic device 100 can alter the received audio information and generate audio signals as described above to be sent to each of the speakers activated for use in this audio mode (e.g., the speakers 120a-d although any speaker 121, 122a-d of the mobile electronic device 100 can optionally be utilized). The sound waves produced by the speakers in the direction of the user 102 can constructively interfere at or near the target focal point (e.g., within a target zone of constructive interference) as described above to provide acceptable volume of the conversation for the user while minimally disturbing those around the user. In one aspect, the video signal can be delayed for display on the screen 111 to compensate for delay in the audio signals due to processing that may cause the audio and video to be “out of sync.” The volume or sound pressure level at the target location or zone can be adjusted as desired by the user. In one aspect, the volume can be controlled by varying the amplitude of the audio signals provided to the speakers. The technology disclosed herein can be beneficial to any user of the mobile electronic device 100 in any setting, although it may be particularly beneficial to users that are hearing impaired (e.g., require a hearing aid) by providing hearing assistance.

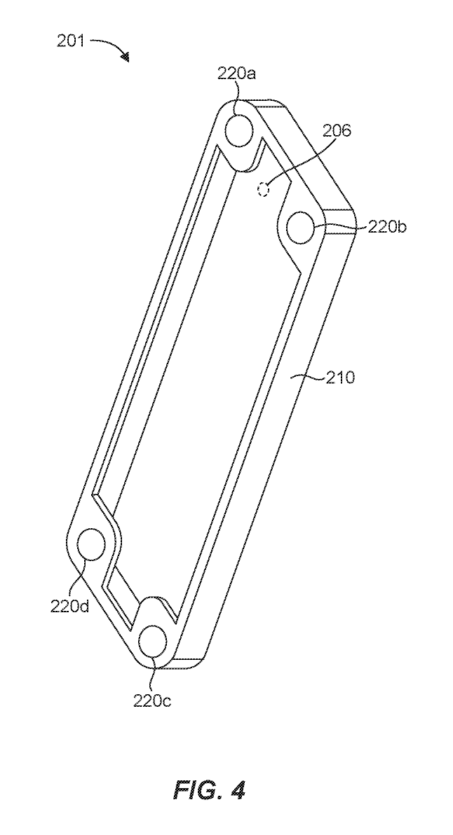

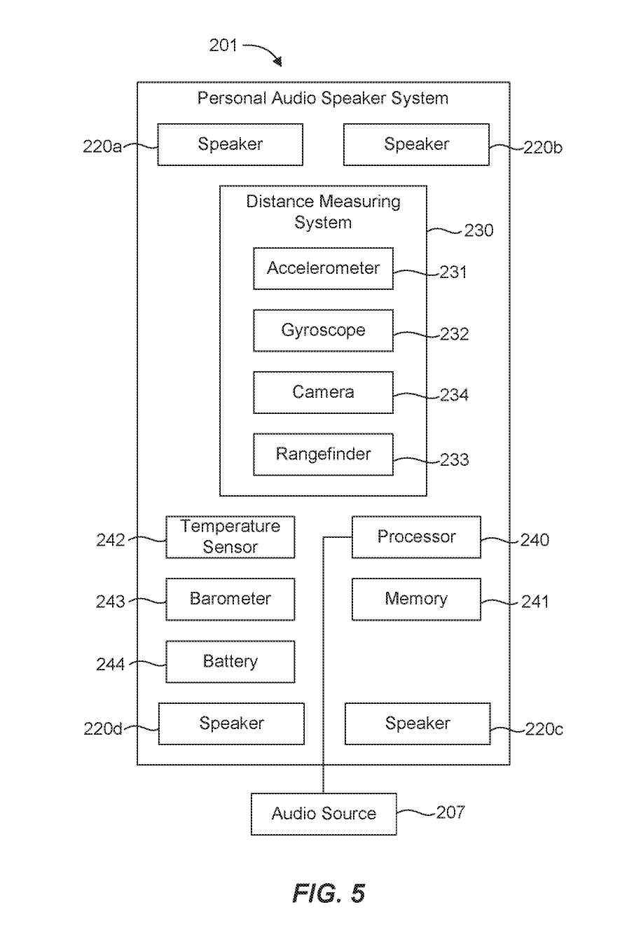

FIGS. 1-3 discussed above pertain to an example of the present technology that is integrated into a mobile electronic device. FIGS. 4 and 5 illustrate an embodiment of the present technology that is separate from a mobile electronic device or other audio source. In particular, FIGS. 4 and 5 illustrate a personal audio speaker system 201 that includes speakers 220a-d supported by a support structure 210. In one aspect, the support structure 210 can be securable about a mobile electronic device or other audio source, such as a mobile phone, a tablet, a wearable device, a laptop computer, etc. For example, the support structure 210 can be configured as a protective case and/or an auxiliary battery case for a mobile electronic device.

In one aspect, the personal audio speaker system 201 can provide additional speakers 220a-d that can receive adjusted audio signals from a mobile electronic device configured to cause sound waves from the speakers 220a-d to superpose in constructive interference at a target location or zone, as described above. Thus, in this case, the mobile electronic device can include hardware (e.g., sensors and processing capabilities) and/or software that can determine the distances between the respective speakers 220a-d and the target location or zone and generate adjusted audio signals accordingly. The personal audio speaker system 201 can provide the speakers 220a-d that generate the sound waves from the signals provided by the mobile electronic device. The distances between the speakers 220a-d and a reference point 206 (FIG. 4) on the mobile electronic device (e.g., a camera, a rangefinder, and/or other sensor used to determine distance to the target location) can be input by the user to facilitate accurately determining the distances of the speakers 220a-d from a target location or zone. In one aspect, the mobile electronic device can include one or more speakers that are activated to generate sound waves that superpose in constructive interference at a target location or zone, such that one or more speakers of the mobile electronic device operate together with the speakers 220a-d of the personal audio speaker system 201. The speakers 220a-d can receive audio signals from the mobile electronic device via any suitable transmission structure or device, such as a wired connection and/or a wireless connection.

In another aspect, the personal audio speaker system 201 can include at least some of the hardware (e.g., sensors and processing capabilities) and/or software (see FIG. 5) needed to determine the distances between the respective speakers 220a-d and the target location or zone and to generate adjusted audio signals as described above. For example, the personal audio speaker system 201 can include a distance measuring system 230 to determine the distances between the speakers 220a-d and a target location or zone. The distance measuring system 230 can include a camera 234, an accelerometer 231, a gyroscope 232, and/or a rangefinder 233 (e.g., an RF rangefinder, an ultrasonic rangefinder, a laser rangefinder, etc.). The personal audio speaker system 201 can also include a processor 240 and one or more memory devices 241 including a data store to store data and instructions. A temperature sensor 242 (e.g., a thermocouple) and/or a barometer 243 can be included as desired to determine the speed of sound in the air. The personal audio speaker system 201 can also include a battery 244 to power onboard devices (e.g., sensors, processor, speakers, etc.). In one example, the battery 244 can be configured to provide auxiliary power for a mobile electronic device. In other examples, the personal audio speaker system 201 does not have a battery and instead relies on an exterior power source, such as a mobile electronic device.

The personal audio speaker system 201 can include hardware (e.g., the distance measuring system 230, the processor 240, and memory 241) and/or software that can determine the distances between the respective speakers 220a-d and the target location or zone and generate adjusted audio signals accordingly, as well as provide the speakers 220a-d that generate the sound waves. In this case, the personal audio speaker system 201 only relies on an external audio source 207, such as a mobile electronic device, to provide an original input audio signal that is processed by the personal audio speaker system 201 in accordance with the present technology. The personal audio speaker system 201 (e.g., the processor 240) can receive the input audio signal from the audio source 207 via a wired connection and/or a wireless connection.

In one aspect, the audio source 207 (e.g., a mobile electronic device) can include one or more speakers that are activated to generate sound waves that superpose in constructive interference at a target location or zone, such that one or more speakers of the mobile electronic device operate together with the speakers 220a-d of the personal audio speaker system 201. The speakers of the audio source 207 can receive audio signals from the personal audio speaker system 201 via any suitable transmission structure or device, such as a wired connection and/or a wireless connection.

In another aspect, the personal audio speaker system 201 and the audio source (e.g., a mobile electronic device) can function together to determine the distances between the various speakers and the target location or zone, generate adjusted audio signals, and generate the sound waves that superpose in constructive interference at the target location or zone. For example, distance data can be acquired by hardware in a mobile electronic device and provided to the personal audio speaker system 201 for processing and generating the adjusted audio signals. The adjusted audio signals can be provided to the speakers 220a-d and/or one or more speakers of the mobile electronic device. In another example, the processing can be shared between the personal audio speaker system 201 and the mobile electronic device. Thus, the personal audio speaker system 201 can be configured to provide any suitable feature or component to enhance the capabilities of the audio source (e.g., a mobile electronic device) to provide sound waves that superpose in constructive interference at a target location or zone as described herein.

In accordance with one example, a method for directing sound to a target location is disclosed. The method can comprise receiving an input audio signal. The method can further comprise generating adjusted audio signals from the input audio signal for a plurality of speakers such that sound waves from the plurality of speakers superpose in constructive interference at a target location. Additionally, the method can comprise transmitting the adjusted audio signals to the plurality of speakers. It is noted that no specific order is required in this method, though generally in one embodiment, these method steps can be carried out sequentially.

In one aspect, the method can further comprise determining a distance between each of the plurality of speakers and the target location. In a particular aspect, generating adjusted audio signals can comprise phase-shifting the input audio signal based on the distance between each of the plurality of speakers and the target location. In another aspect, the method can further comprise identifying a reference speaker of the plurality of speakers that is at the greatest distance from the target location, and delaying sound waves produced by the other of the plurality of speakers closer to the target location relative to sound waves produced by the reference speaker such that the sound waves of the plurality of speakers superpose in constructive interference at the target location.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, or other medium for storing electronic data. The satellite may also include a transceiver module, a counter module, a processing module, and/or a clock module or timer module. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of functional units described in this specification may be labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

It is to be understood that the examples set forth herein are not limited to the particular structures, process steps, or materials disclosed, but are extended to equivalents thereof as would be recognized by those ordinarily skilled in the relevant arts. It should also be understood that terminology employed herein is used for the purpose of describing particular examples only and is not intended to be limiting.

Furthermore, the described features, structures, or characteristics may be combined in any suitable manner in one or more examples. In the description, numerous specific details are provided, such as examples of lengths, widths, shapes, etc., to provide a thorough understanding of the technology being described. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts described herein. Accordingly, it is not intended that the invention be limited, except as by the claims set forth below.

1. A personal audio speaker system, comprising:
a portable support structure operable to be supported by a user; and
a plurality of speakers supported by the portable support structure,
wherein the plurality of speakers receive adjusted audio signals based on the distance between each of the plurality of speakers and a target location, such that sound waves produced from the plurality of speakers superpose in constructive interference at the target location.

2. The personal audio speaker system of claim 1, wherein the sound waves are in phase at the target location.

3. The personal audio speaker system of claim 1, wherein a reference speaker of the plurality of speakers is at the greatest distance from the target location, and the other of the plurality of speakers closer to the target location produce sound waves that are delayed relative to sound waves produced by the reference speaker such that the sound waves of the plurality of speakers superpose in constructive interference at the target location.

4. The personal audio speaker system of claim 1, wherein the plurality of speakers comprises four speakers.

5. The personal audio speaker system of claim 1, further comprising a distance measuring system to determine the distance between each of the plurality of speakers and a target location about the user.

6. The personal audio speaker system of claim 5, wherein the distance measuring system comprises an accelerometer, a gyroscope, a camera, an RF rangefinder, an ultrasonic rangefinder, a laser rangefinder, or a combination thereof.

7. The personal audio speaker system of claim 1, further comprising a processor that receives an input audio signal and generates the adjusted audio signal for at least one of the plurality of speakers such that the sound waves from the plurality of speakers superpose in constructive interference at the target location.

8. The personal audio speaker system of claim 7, wherein the processor receives the input audio signal from an audio source via a wired connection, a wireless connection, or a combination thereof.

9. The personal audio speaker system of claim 8, wherein the audio source comprises a mobile electronic device.

10. The personal audio speaker system of claim 9, wherein the processor provides at least one of the adjusted audio signals to the mobile electronic device to facilitate production of a sound wave by a mobile electronic device speaker that superposes in constructive interference with the sound waves produced from the plurality of speakers at the target location.

11. The personal audio speaker system of claim 1, wherein at least two of the plurality of speakers face the same direction.

12. The personal audio speaker system of claim 1, wherein the target location is an ear of the user.

13. The personal audio speaker system of claim 1, wherein the plurality of speakers receive the adjusted audio signals from a mobile electronic device.

14. The personal audio speaker system of claim 13, wherein the plurality of speakers receive the adjusted audio signals from the mobile electronic device via a wired connection, a wireless connection, or a combination thereof.

15. The personal audio speaker system of claim 1, wherein the support structure is coupleable to a mobile electronic device such that the plurality of speakers are portable with the mobile electronic device.

16. The personal audio speaker system of claim 15, wherein the plurality of speakers are located on a screen side of the mobile electronic device.

17. The personal audio speaker system of claim 15, wherein sound waves are directed in the same direction from the mobile electronic device.

18. The personal audio speaker system of claim 15, wherein the support structure is configured as a protective case for the mobile electronic device.

19. The personal audio speaker system of claim 15, wherein the mobile electronic device comprises a smart phone, a tablet, a wearable device, a laptop computer, or a combination thereof.

20. A mobile electronic device, comprising:
a portable support structure operable to be supported by a user;
a plurality of speakers supported by the portable support structure;
a distance measuring system to determine a distance between each of the plurality of speakers and a target location about the user; and
a processor that receives an input audio signal and generates adjusted audio signals for the plurality of speakers based on the distance between each of the plurality of speakers and the target location such that sound waves produced from the plurality of speakers superpose in constructive interference at the target location.

21. The mobile electronic device of claim 20, wherein the sound waves are in phase at the target location.

22. The mobile electronic device of claim 20, wherein a reference speaker of the plurality of speakers is at the greatest distance from the target location, and the other of the plurality of speakers closer to the target location produce sound waves that are delayed relative to sound waves produced by the reference speaker such that the sound waves of the plurality of speakers superpose in constructive interference at the target location.

23. The mobile electronic device of claim 20, wherein the plurality of speakers comprises four speakers.

24. The mobile electronic device of claim 20, wherein the distance measuring system comprises an accelerometer, a gyroscope, a camera, an RF rangefinder, an ultrasonic rangefinder, a laser rangefinder, or a combination thereof.

25. The mobile electronic device of claim 24, wherein the distance measuring system utilizes the processor.

26. The mobile electronic device of claim 20, wherein sound waves are directed in the same direction from the mobile electronic device.

27. The mobile electronic device of claim 20, wherein the target location is an ear of the user.

28. The mobile electronic device of claim 20, wherein the plurality of speakers are located on a screen side of the mobile electronic device.

29. The mobile electronic device of claim 20, wherein the mobile electronic device comprises a smart phone, a tablet, a wearable device, a laptop computer, or a combination thereof.

30. A method for directing sound from a portable device to a target location, comprising:
supporting a plurality of speakers by a portable support structure that is operable to be supported by a user;
generating adjusted audio signals from an input audio signal for the plurality of speakers such that sound waves from the plurality of speakers superpose in constructive interference at a target location; and
transmitting the adjusted audio signals to the plurality of speakers.

31. The method of claim 30, further comprising determining a distance between each of the plurality of speakers and the target location.

32. The method of claim 31, wherein generating adjusted audio signals comprises phase-shifting the input audio signal based on the distance between each of the plurality of speakers and the target location.

33. The method of claim 3030, further comprising:
identifying a reference speaker of the plurality of speakers that is at the greatest distance from the target location; and
delaying sound waves produced by the other of the plurality of speakers closer to the target location relative to sound waves produced by the reference speaker such that the sound waves of the plurality of speakers superpose in constructive interference at the target location.
